(19) United States
(12) Patent Application Publication
(10) Pub. No.: US 2002/0164425 A1
(43) Pub. Date: Nov. 7, 2002

(54) Method for treating iron based parts

(76) Inventors: Douglas Charles Rivard, Maastricht (NL); Marco Franciscus Wilhelmus Halmans, Susteren (NL); Martijn Jan Hubert Isenborghs, Amstenrade (NL); Gregory Steven Clark, Harrison, MI (US)

Correspondence Address: DOUGLAS W. SPRINKLE, Gifford, Krass, Groh, Sprinkle, Anderson & Citkowski, P.C., 280 N. Old Woodward, Suite 400, Birmingham, MI, 48009, US

(21) Appl. No.: 09/844,461

(22) Filed: Apr. 27, 2001

(51) Int. Cl. B05D 3/00; B05D 1/36; B05D 7/00; B05D 1/04; B08B 3/12; B08B 6/00; B08B 7/00

(52) U.S. Cl. 427/318; 427/402; 427/327; 134/1

(57) ABSTRACT

A method is disclosed for treating iron based parts. The method includes the steps of immersing the parts in an alkaline based degreasing solution and simultaneously subjecting the alkaline based degreasing solution to ultrasonic vibration. Thereafter, the parts are rinsed in the water bath and, following the water rinse, immersed in a water soluble corrosion based inhibiter. The parts are then dried and, subsequent to drying, painted to protect the parts from corrosion.

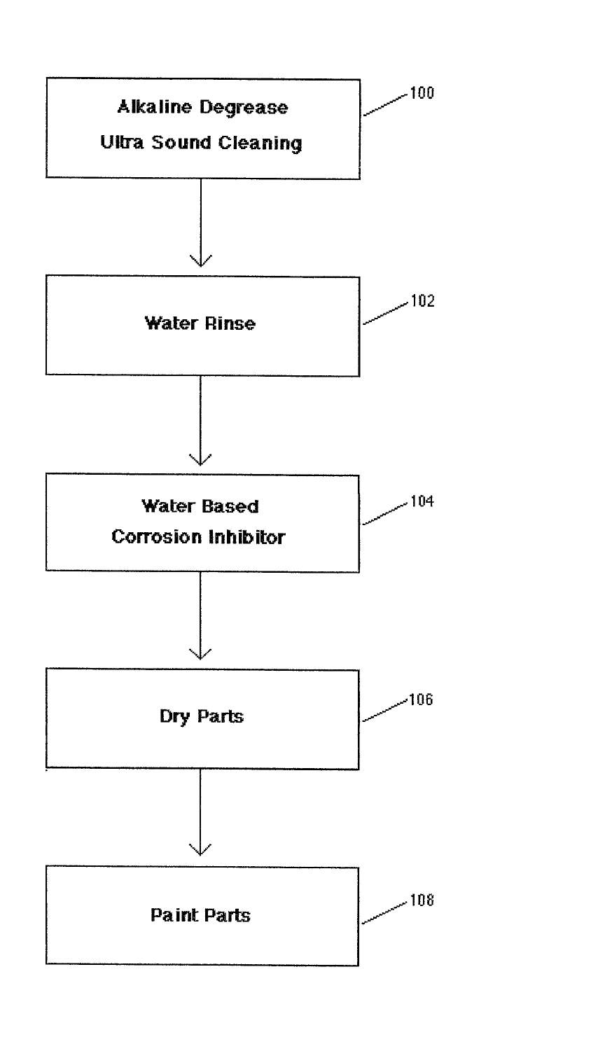

### BACKGROUND OF THE INVENTION

I. Field of the Invention

The present invention relates generally to a method for treating iron based parts to prevent corrosion by oxidation.

II. Description of the Prior Art

There have been many previously known methods for treating iron based parts to prevent the subsequent corrosion of the parts by oxidation. Such metal treating methods are conventionally used in industry, such as the automotive industry.

These previously known methods for treating iron based parts to prevent corrosion by oxidation have suffered from a number of disadvantages. For example, many of the previously known methods for treating parts require the use of expensive chemical treatments and coatings for the metal part in order to prevent corrosion by oxidation of the metal parts.

### SUMMARY OF THE PRESENT INVENTION

The present invention provides a method for treating iron based parts, such as iron or steel, to prevent corrosion of the parts by oxidation. The method of the present invention, furthermore, enjoys particular utility in the manufacturing industry, such as manufacturing parts for the automotive industry.

In brief, according to the present invention, the metal parts are first immersed in an alkaline based degreasing solution and simultaneously subjected to ultrasonic vibration. Preferably, the degreasing solution is heated to a temperature of between 60° and 75° centigrade while the ultrasonic vibration is preferably in the range of 20 kHz-40 kHz.

Following immersion of the parts in the alkaline based degreasing solution, the parts are then rinsed in a water bath to remove the alkaline based degreasing solution from the parts. Preferably, the water bath is agitated through aeration to ensure complete removal of the alkaline based degreasing solution from the parts.

After the water rinse, the parts are immediately immersed in a water soluble corrosion inhibiter which is preferably organic based. Following immersion, the parts are removed from the water soluble corrosion inhibiter, dried, and thereafter painted. Preferably, the parts are painted almost immediately following drying of the parts after the immersion in the water soluble corrosion inhibiter. However, following the painting step, the parts are fully protected from corrosion through oxidation for an indefinite period of time.

### BRIEF DESCRIPTION OF THE DRAWING

A better understanding of the present invention will be had upon reference to the following detailed description, when read in conjunction with the drawing, which illustrates a flow diagram of the preferred embodiment of the present invention.

### DETAILED DESCRIPTION OF A PREFERRED EMBODIMENT OF THE PRESENT INVENTION

With reference then to the drawing, at step 100, the iron based parts, such as iron or steel parts, are first immersed in an alkaline based degreasing solution for approximately one minute. The degreasing solution is preferably a 10-13% solution of Ridoline® from Henkel with the balance water although other alkaline based degreasing solutions may alternatively be used. The alkaline based degreasing solution preferably has a pH in the range of 12-13. Furthermore, the alkaline based degreasing solution is preferably heated to a temperature of 60-75° centigrade to enhance the degreasing and cleaning action of the bath on the parts.

At step 100, the alkaline based degreasing solution and thus the parts immersed in the degreasing solution, are subjected to ultrasonic vibration in the range of 25 kHz-40 kHz. The amount of power required for the ultrasonic generators will vary depending upon the size of the bath containing the alkaline based degreasing solution. However, for a bath containing 7500 liters, ultrasonic power in the range of approximately 3000 watts for approximately one minute has proven effective in completely degreasing and cleaning the iron based parts.

Following the cleaning of the iron parts in the alkaline based degreasing solution, the parts are then cleaned of the degreasing solution by immersing the parts in a water rinse bath at step 102. Preferably, the water bath is agitated, preferably through aeration, to ensure the complete removal of the alkaline based degreasing solution. In the preferred embodiment of the invention, the parts are immersed in the water rinse bath at step 102 for approximately one minute.

After rinsing the parts in step 102, the parts are then immersed in a water solution corrosion inhibiter which is preferably organic based at step 104 for approximately one minute. In the preferred embodiment of the invention, the water solution corrosion inhibiter comprises a 2-5% solution of Deoxylyte® from Henkel. This corrosion inhibiter is a non-chrome corrosion inhibiter which coats the iron based parts in preparation for their final seal.

Following the immersion of the parts in the water soluble corrosion inhibiter at step 104, the parts are removed and dried at step 106. Any conventional drying method, such as heated air drying, can be utilized to dry the parts.

After the parts are dried at step 106, the parts are painted at step 108. In practice, the parts are typically immediately painted after drying thus completing the sealing of the iron based parts. However, following the cleaning step, the parts are stable for an indefinite period of time and thus protected from corrosion. The paint thus protects the parts from corrosion by oxidation.

As can be seen from the foregoing, the present invention provides a simple, inexpensive and rapid method for treating iron based parts to render the parts corrosion resistant.

Having described our invention, however, many modifications thereto will become apparent to those skilled in the art to which it pertains without deviation from the spirit of the invention as defined by the scope of the appended claims.

We claim:

1. A method for treating iron based parts comprising the steps of:
immersing said parts in an alkaline based degreasing solution and simultaneously subjecting said alkaline based degreasing solution to ultrasonic vibration,
thereafter, rinsing said parts in a water bath,
thereafter immersing said parts in a water soluble corrosion inhibiter, drying said parts, and
thereafter, painting the parts.

2. The invention as defined in claim 1 wherein said alkaline based degreasing solution has a pH in the range of 12-13.

3. The invention as defined in claim 1 and further comprising the step of heating said alkaline based degreasing solution to a temperature of 60-75° centigrade prior to immersing said parts in said alkaline based degreasing solution.

4. The invention as defined in claim 1 wherein said ultrasound subjecting step further comprises the step of subjecting said parts in said alkaline based degreasing solution to ultrasonic vibration in the range of 25 kHz-40 kHz.

5. The invention as defined in claim 1 and further comprising the step of agitating said rinse bath.

6. The invention as defined in claim 5 wherein said agitating step comprises the step of aerating said rinse bath.

7. The invention as defined in claim 1 wherein said water soluble corrosion inhibiter comprises a 2-5% solution of water soluble corrosion inhibiter with the balance water.

8. The invention as defined in claim 1 wherein said painting step occurs not later than two weeks after said drying step.

9. The invention as defined in claim 1 wherein said drying step further comprises the step of heating said parts.
